(19) United States
(12) Patent Application Publication
(10) Pub. No.: US 2026/0334372 A1
(43) Pub. Date: Oct. 29, 2026

(54) BALER AND METHOD FOR FORMING ROUND BALES

(71) Applicant: KVERNELAND GROUP RAVENNA S.R.L., Russi (Ravenna) (IT)

(72) Inventors: Cosimo FRASCELLA, Lugo (RA) (IT); Maurizio VECCHI, Russi (RA) (IT)

(21) Appl. No.: 19/485,983

(22) PCT Filed: May 22, 2024
(86) PCT No.: PCT/IB2024/054978

§ 371 Date: Nov. 19, 2025

(30) Foreign Application Priority Data
May 23, 2023 (IT) 102023000010374

(51) Int. Cl. A01F 15/10; A01F 15/07

(52) U.S. Cl. CPC A01F 15/106; A01F 15/0715; A01F 2015/076

(57) ABSTRACT

A baler for forming round bales comprises: a fixed-diameter compression chamber for receiving and compressing crop picked up from the ground; a plurality of rotating rollers surrounding the compression chamber; a binding device for injecting a plastic film into the compression chamber to bind the bale; a control unit which, responsive to a bale formation parameter, generates a binding signal to start injecting the plastic film, and generates a stop signal to stop feeding the crop into the compression chamber with a predetermined time delay with respect to the binding signal; an inspection unit configured to detect binding errors. The control unit, responsive to detection of an error, restarts injecting the film and feeding the crop, so that the crop continues entering the compression chamber for a time interval after the film restarts being injected.

### TECHNICAL FIELD

This invention relates to a baler for forming round bales and to a method for forming round bales.

BACKGROUND ART Balers for forming round bales (round balers) are the most common type of balers that can be hitched to the back of a towing vehicle such as a tractor to pick up from the ground previously cut agricultural crops such as rice straw, grass, wheat straw, maize straw and the like (hereinafter referred to as “hay”) and to form a bale from the hay and unload it onto the field. Typically, round balers have a feeding unit for picking up the hay from the ground, a compression chamber for forming the round bales and a rotary apparatus for feeding the hay from the ground to the compression chamber of the press. The compression chamber may be a fixed-diameter or a variable-diameter compression chamber. In particular, a baler with a fixed-diameter compression chamber includes a plurality of rollers that delimit the compression chamber. The plurality of rollers rotate about a rotation axis, thereby imparting rotational movements to the hay fed into the compression chamber.

Once formed inside the compression chamber, the bales are bound with a binding material. The bale can be bound with different kinds of material: for example, netting or cord. In addition, the bale bound with the binding material may also be wrapped in a film (usually of plastic material); in this case, the film is applied after the bale has been bound.

Generally speaking, therefore, the film is wrapped round the bale outside the compression chamber, after the bale has been released by the press. Also known in the prior art are solutions where the bale is wrapped in the film inside the press (inside the compression chamber); in these cases, once the bale has been formed inside the compression chamber, it is wrapped directly in the film without first being bound with the cord or net; thus, in these cases, the binding material is the film. In such a case, therefore, the plastic film is applied directly on the formed bale, inside the compression chamber.

The present solution refers to such a situation, where the bale is wrapped in the film directly in the compression chamber, which means, in practice, that binding and wrapping coincide.

Thus, the baler comprises a binding (wrapping) device and the bale is wrapped after being formed and when it is still inside the compression chamber. In particular, in these solutions, the binding material (that is, the film) is fed out by a binding device mounted inside the baler and is wrapped round the formed bale. In particular, the binding material is fed into the compression chamber and between the rotating rollers and the bale, and is moved around a circumference of the bale by the rolling movements of the bale and of the plurality of rotating rollers. One of the problems that may be encountered is that, if the bale binding material is a film, when the binding material comes out of the binding device, it may, in some cases, not follow the correct path and, instead, may become entangled round one or more of the plurality of rollers, for example.

In this context, patent document WO2019038017A1, in the name of the present Applicant, discloses a nonstop baler having a prechamber where the core of the bale is formed, a main chamber where the bale continues to increase in size and where the hay is compressed to form the bale and including a binding device. When the binding process begins, the flow of hay continues entering the main chamber for a predefined length of time. This solution allows preventing the film from not following the correct path. Further examples of known balers are disclosed by patent documents GB2163387A and US2009107102A.

However, the balers of the prior art have some disadvantages and can be improved. In effect, in this field there is a need to improve the reliability of balers, above all with regard to the bale binding process.

### AIM OF THE INVENTION

The aim of this disclosure is to provide a baler and a method for forming round bales to overcome the above mentioned disadvantages of the prior art.

These aims are fully achieved by the baler and the method of this disclosure, as characterized in the appended claims.

According to an aspect of it, this disclosure provides a baler. The baler is adapted for forming round bales. The baler comprises a pick-up unit. The pick-up unit is configured to pick up the crop from the ground. The crop includes previously cut agricultural crops such as rice straw, grass, wheat straw, maize straw and the like. The apparatus comprises a compression chamber. The compression chamber is adapted for receiving the crop from the pick-up unit. The compression chamber is adapted for compressing the crop to form the bale. The compression chamber has a fixed diameter.

The baler comprises a plurality of rotating rollers. The rotating rollers surround the compression chamber. The rotating rollers are configured for imparting a rotational movement to the crop positioned inside the compression chamber. The baler includes a binding device. The binding device is configured for injecting a binding material into the compression chamber. In particular, the binding device injects the binding material into the compression chamber so that the bale is wrapped by the binding material as a result of the rotational movement of the crop. The binding material is a plastic film. It should be noted that by “binding material” is meant the material used to wrap the bale. The baler includes a control unit.

The control unit is configured to receive a bale formation parameter. The bale formation parameter is representative of the bale formation inside the compression chamber. The control unit is configured to generate a binding signal responsive to the bale formation parameter. The binding signal is used to command the binding device to inject the plastic film into the compression chamber. The control unit is also configured to generate a stop signal. The stop signal is representative of the need to stop feeding the crop into the compression chamber.

The control unit is programmed to generate the stop signal with a predetermined time delay with respect to the binding signal. The control unit generates the stop signal with said predetermined time delay with respect to the binding signal, so that the crop continues entering the compression chamber for a time interval after the injection of the plastic film into the compression chamber. The baler also includes an inspection unit. The inspection unit is configured to detect errors in the binding process. The control unit is connected to the inspection unit. The control unit is programmed to restart the binding device and to restart feeding the crop into the compression chamber responsive to the inspection unit detecting an error. In particular, the control unit restarts the binding device and restarts feeding the crop into the compression chamber when an error in the binding process is detected, so that the crop continues entering the compression chamber for the time interval after the binding device is restarted.

According to an aspect of this disclosure, therefore, when the binding device starts injecting the plastic film into the compression chamber, feeding of the crop into the compression chamber is not stopped immediately and the crop continues entering for a time interval. This delay in stopping crop feed into the compression chamber allows preventing the plastic from being diverted from the required path (thus, it is not wrapped round the bale). Furthermore, according to this disclosure, when an error in the binding of the bale is detected, the control unit commands the binding device to re-inject the plastic film into the compression chamber and commands crop feeding into the compression chamber. This solution allows restarting a new binding cycle so as to obtain a reliable binding process even in the event of a binding error.

In an example, the inspection unit includes a film sensor. The film sensor is positioned at a predetermined point of the compression chamber. The film sensor is configured to detect the presence of the plastic film on the bale formed in the compression chamber at said predetermined point. The film sensor can therefore be used to detect a binding error.

In an example, the film sensor is an optical sensor. Alternatively, other devices may be used to detect the presence of the film on the bale. In an example, the film sensor is positioned between two consecutive rotating rollers of the plurality of rotating rollers.

In an example, the film sensor is located at an upper part of the baler. The film sensor is located downstream of the binding device. It is therefore possible to detect the presence of the film on the bale after the film is injected into the compression chamber and at a predetermined point. The predetermined point may be proximal to the point where the film is injected. There may be several predetermined points around the compression chamber, spaced from each other, where the film sensor is located.

In an example, the control unit is configured to activate the film sensor in response to the generation of the binding signal.

In an example, the baler includes a prechamber. The prechamber is separate from the compression chamber. The baler includes a first feeding channel. The first feeding channel is configured to feed the crop into the prechamber.

The baler also includes a second feeding channel. The second feeding channel is configured to feed the crop into the compression chamber.

In this example, the control unit is configured to activate the first feeding channel and to deactivate the second feeding channel, so that a core of the bale is formed inside the prechamber. The control unit is also configured to subsequently activate the second feeding channel and to deactivate the first feeding channel upon transfer of the bale core formed inside the prechamber to the compression chamber, so that the bale is formed inside the compression chamber. The control unit is also configured to deactivate the second feeding channel and to activate the first feeding channel to switch the feeding of the crop from the second feeding channel to the first feeding channel upon generation of the stop signal. The control unit is configured, responsive to detection of an error by the inspection unit, to restart the binding device and to switch the feeding of the crop from the first feeding channel to the second feeding channel. In particular, if a binding error is detected, the control unit commands the switching of crop feeding from the first feeding channel to the second feeding channel, so that the crop continues entering the compression chamber for the time interval after the binding device is restarted.

In an example, the baler may also include a movable plate. In this example, the control unit is configured to activate the first feeding channel and the second feeding channel by moving the movable plate between the first and the second feeding channel so that feeding of the crop is switched between the prechamber and the compression chamber.

In an example, the control unit is configured to command the inspection unit, in response to the binding signal, to verify the presence of the crop inside the compression chamber. Responsive to the binding signal, the control unit is also configured to command the inspection unit to detect the position of the movable plate relative to the first and the second feeding channel. The control unit is configured to move the movable plate into the first feeding channel in response to the following conditions being true:
(i) the crop is present inside the compression chamber,
(ii) the movable plate is in the second feed channel.

In another example, the control unit may be configured to send a stop alert to the operator to stop advancing the baler in response to the generation of the stop signal. In particular, in this example, when the stop signal is generated, the baler must be stopped to stop feeding the crop into the compression chamber.

In an example, the control unit is configured to restart feeding the crop into the compression chamber prior to restarting the binding device.

Alternatively, crop feed into the compression chamber may be restarted at the same time as the binding device is restarted.

In an example, said time delay is a preestablished time window. In this example, therefore, the time delay is not determined at each cycle and is a fixed time interval.

In another example, the time delay is determined based on a binding parameter. In this example, therefore, the time delay is not determined at each cycle and is not a fixed time interval and is determined for each binding cycle and is variable based on said binding parameter.

In an example, the binding parameter represents a position of the plastic film on the circumference of the compression chamber. Alternatively, the binding parameter may represent other values detected inside the compression chamber. For example, the binding parameter may be the position of the film on the circumference of the bale.

According to another aspect of it, this disclosure provides a method for forming round bales.

The method comprises a step of providing a baler for forming round bales. The baler for forming round bales (that is, the baler) includes a compression chamber. The compression chamber has a fixed diameter. The baler includes a plurality of rotating rollers surrounding the compression chamber.

The method comprises a step of feeding the crop into the compression chamber of the baler. The method comprises a step of rotating the plurality of rotating rollers. The method comprises a step of imparting a rotational movement to the crop inside the compression chamber by rotating the plurality of rotating rollers. The method comprises a step of compressing the crop inside the compression chamber to form the bale. The method comprises a step of injecting a binding material into the compression chamber through a binding device. The binding material is a plastic film.

The method includes a step of wrapping the bale with the binding material.

In particular, the binding material moves around the bale on account of the rotational movement of the crop inside the compression chamber.

The method also comprises a step of controlling the injection of the binding material into the compression chamber and the feeding of the crop into the compression chamber by means of a control unit.

The method comprises a step of detecting a bale formation parameter. The bale formation parameter is representative of the bale formation inside the compression chamber. The method also comprises a step of sending the bale formation parameter to the control unit. The method comprises a step, via the control unit, of generating a binding signal to command the binding device to inject the plastic film into the compression chamber upon receiving the bale formation parameter.

The method also comprises a step, via the control unit, of generating a stop signal representative of the need to stop feeding the crop into the compression chamber. In particular, the control unit generates the stop signal with said preset time delay with respect to the binding signal, so that the crop continues entering the compression chamber for a time interval after the injection of the plastic film into the compression chamber.

The method comprises a step, via an inspection unit, of detecting errors in the binding process. The inspection unit is connected to the control unit.

The method comprises a step, via the control unit, of restarting the binding device and restarting to feed the crop into the compression chamber when an error is detected. The control unit restarts the binding device and restarts feeding the crop into the compression chamber when an error in the binding process is detected, so that the crop continues entering the compression chamber for the time interval after the binding device is restarted.

In an example, the method comprises a step of positioning a film sensor of the inspection unit at a predetermined point of the compression chamber. In this example, the method comprises a step, via the film sensor, of detecting the presence of the plastic film on the bale formed in the compression chamber at said predetermined point.

In an example, the method comprises a step of feeding the crop into a prechamber of the baler through a first feeding channel. The prechamber is separate from the compression chamber.

The method comprises a step of forming a core of the bale inside the prechamber. The method comprises a step of transferring the core of the bale into the compression chamber. In particular, the core of the bale is transferred into the compression chamber when the core of the bale is completely formed. The method also comprises a step of stopping crop feed to the prechamber and starting crop feed to the compression chamber through a second feeding channel when the core of the bale is transferred into the compression chamber.

The method comprises a step of stopping crop feed to the second feeding channel and starting to feed the crop to the first feeding channel when the stop signal is generated. The method also comprises a step of restarting the binding device and switching the feeding of the crop from the first feeding channel to the second feeding channel when an error in the binding process is detected, so that the crop continues entering the compression chamber for the time interval after the binding device is restarted.

In another example, a stop alert is sent to the operator to stop advancing the baler when the stop signal is generated. In this example, therefore, the baler does not include a prechamber (and thus it is not a nonstop baler) and stopping the feeding of the crop into the compression chamber is done by stopping the baler. In an example, feeding of the crop is restarted before restarting the injection of the plastic film into the compression chamber, when an error is detected in the binding process.

### BRIEF DESCRIPTION OF THE DRAWINGS

These and other features will become more apparent from the following description of a preferred embodiment, illustrated purely by way of non-limiting example in the accompanying drawings, in which:

FIG. 1 illustrates a baler for forming round bales according to this disclosure;

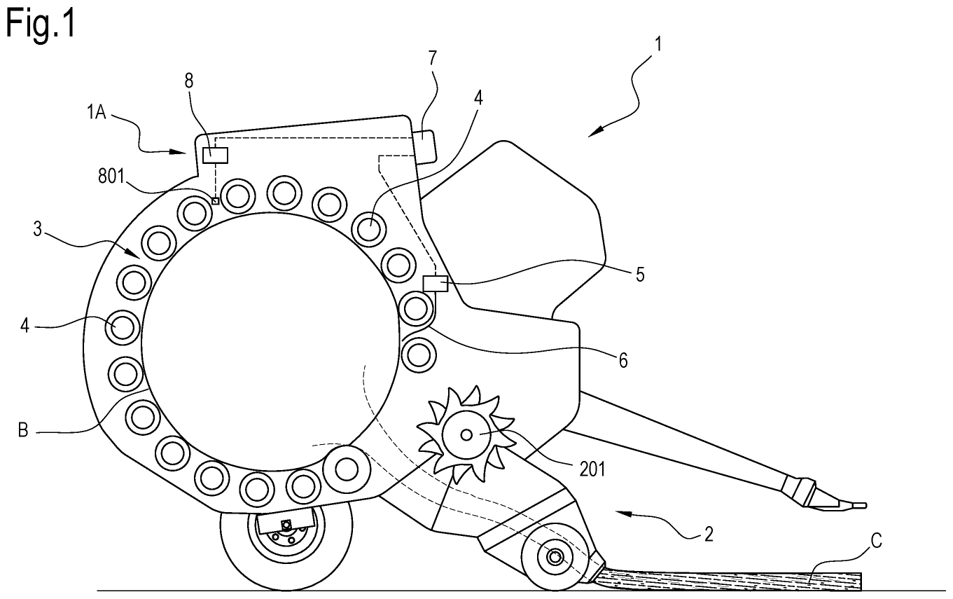

FIG. 2 illustrates the example where the baler includes a prechamber;

FIGS. 3A and 3B illustrate how injection of the plastic film and feeding of the crop are controlled.

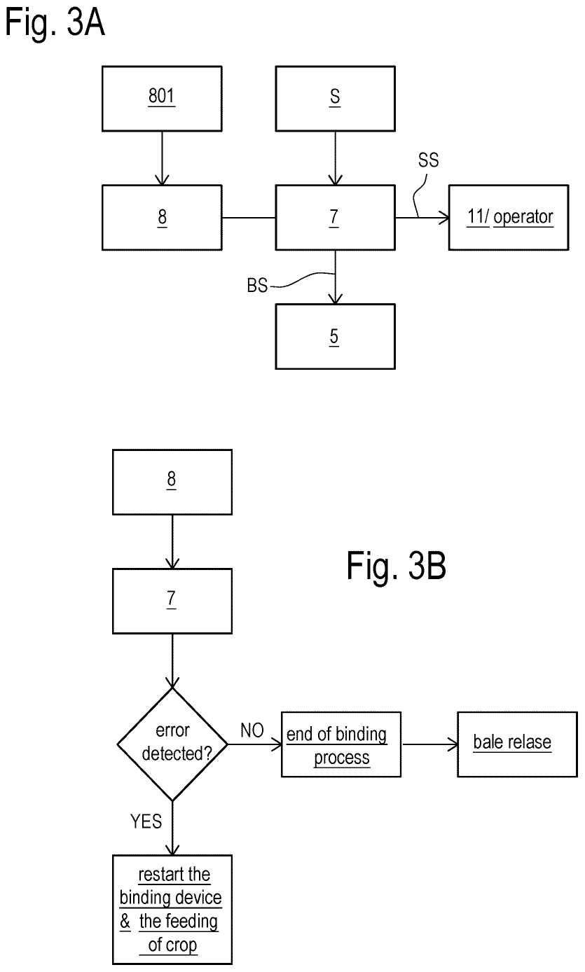

### DETAILED DESCRIPTION OF PREFERRED EMBODIMENTS OF THE INVENTION

With reference to the accompanying drawings, the numeral 1 denotes a baler for forming round bales B. The baler 1 for forming round bales (that is, the baler) includes a pick-up unit 2. The pick-up unit is configured to pick up crop C from the ground. The baler 1 includes a compression chamber 3 for receiving the crop C from the pick-up unit 2 and for compressing the crop C to form the bale B, the compression chamber 3 being of fixed diameter. The pick-up unit may include a rotor 201 for conveying the crop C from the ground to the compression chamber 3. Rotors in this field are known and the function of the rotor is therefore not described in this disclosure.

The baler 1 includes a plurality of rotating rollers 4. The rotating rollers delimit the compression chamber 3 and rotate about an axis of rotation, thereby imparting rotational motion to the crop moving inside the compression chamber. The baler 1 also includes a binding device 5 which injects a binding material into the compression chamber. The binding material is a plastic film. The binding device is preferably located on an upper part 1A of the baler. In an example, the binding device is located outside the compression chamber and near the rotating rollers. In particular, when the film passes between the rollers and enters the compression chamber, it is positioned between the crop and the rollers and is entrained round the bale by the rotational movement of the roller and of the crop itself.

The baler 1 includes a control unit 7. The control unit receives a bale formation parameter BP representative of the bale formation inside the compression chamber 3. The control unit may receive said bale formation parameter BP from a detection unit such as a sensor S, for example. In an example, the bale formation parameter BP may be representative of the density of the bale. Responsive to the bale formation parameter BP, the control unit 7 generates a binding signal BS to command the binding device 5 to inject the plastic film 6 into the compression chamber 3. Thus, the bale formation parameter determines the completion of the bale B formed inside the compression chamber 3 and the need to start the bale binding process. The control unit 7 also generates a stop signal SS representative of the need to stop feeding the crop C into the compression chamber 3.

The control unit 7 generates the stop signal SS with a predetermined time delay with respect to the binding signal BS, so that the crop C continues entering the compression chamber 3 for a time interval after the injection of the plastic film 6 into the compression chamber 3. In an example, the time delay may be a preestablished time window. In this example, therefore, after the film starts being injected into the compression chamber, the crop C continues to be fed into the compression chamber 3 for the preestablished time window (which may last for a few seconds, for example) at each binding cycle.

Alternatively, said time delay is variable and is determined based on a binding parameter, for each binding cycle. For example, the binding parameter may be a position of the plastic film 6 on the circumference of the compression chamber 3.

The baler 1 also includes an inspection unit 8. The inspection unit detects errors in the binding process. Errors in the binding process comprise errors where the plastic film does not follow the right path (around the bale B). In an example, the inspection unit 8 includes a film sensor 801. In an example, the film sensor may be a camera. The film sensor is positioned at a predetermined point of the compression chamber 3 and is configured to detect the presence of the plastic film 6 on the bale B formed in the compression chamber 3 at said predetermined point. The predetermined point may be positioned between two consecutive rotating rollers 4 of the plurality of rotating rollers. Furthermore, the sensor may be located at an upper part 1A of the baler and downstream of the binding device 5. The film sensor 801 may be an optical sensor. The inspection unit 8 is connected to the control unit 7. Preferably, the film sensor 801 is activated by the control unit 7 responsive to the generation of the binding signal BS.

If an error in the binding process is detected by the inspection unit 8, the control unit restarts the binding device 5 and restarts feeding the crop into the compression chamber 3 so that the crop continues entering the compression chamber for the time interval after the binding device 5 is restarted.

In an example, the baler 1 includes only one chamber (the compression chamber) which receives the product picked up; in this example, when the stop signal SS is generated by the control unit 7, an alert is transmitted for the operator to stop the baler, thereby stopping the crop from being fed into the compression chamber 3. In this case, therefore, crop feed to the compression chamber is stopped by the operator by stopping the baler so that bale binding can be started. Also in this example, when a binding error is detected by the control unit or, in some cases, by the user, the baler allows the binding device 5 to be restarted.

The binding device 5 may be restarted automatically by the control unit or manually by the user (for example, by selecting a command which appears on the display visible to the user on the tractor). In response to a command (automatic or manual) for restarting the binding device 5, the control unit preferably proceeds to checking for the following conditions: (i) tailgate closed, (ii) bale present in the forming chamber (compression chamber). If the control unit, responsive to the command for restarting the binding device 5, detects (through suitable tailgate closed and bale present sensors) that the above conditions (i) and (ii) are both true at the same time, the control unit restarts the binding device 5 (film injection into the compression chamber) and to prompt the user (with a command or signal that appears on the display) to restart the baler moving in order to restart crop feed; that way, the crop C restarts entering the compression chamber, at the same time as (or just before) binding is restarted. In this example, the binding device may be restarted manually by the operator or automatically by the control unit. Thus, when the binding device 5 and the feeding of the crop C are restarted, on account of a binding error, a new binding cycle starts, and another stop signal (and said alert to restart the baler moving) is generated with the predetermined time delay (as described above) with respect to the binding signal.

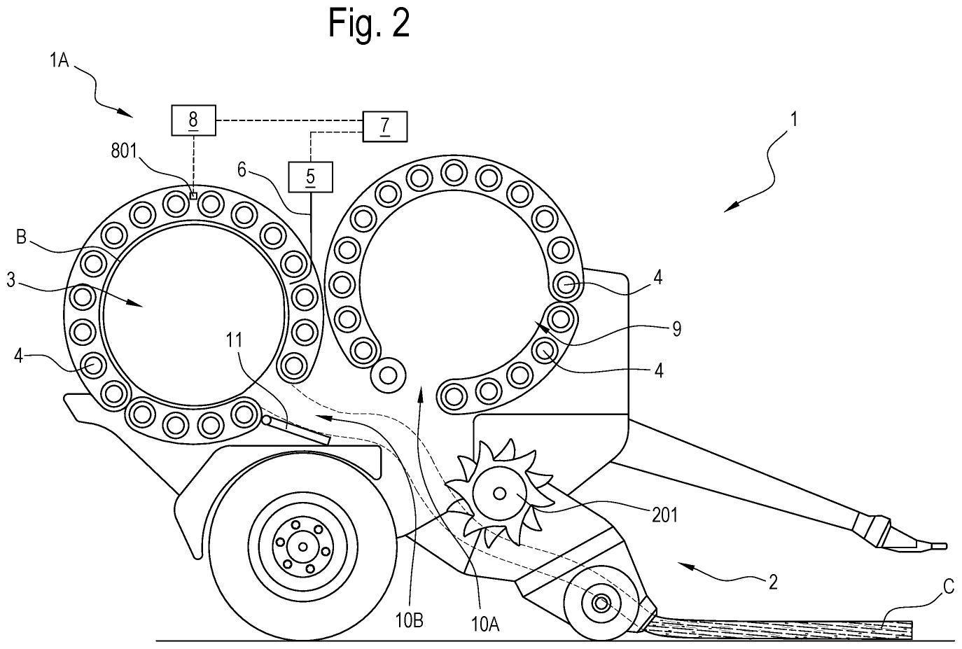

In another example, the baler may be a nonstop baler. In this example, the baler 1 includes a prechamber 9 (FIG. 2). The prechamber is separate from the compression chamber and is in communication with the compression chamber. In particular, at the start of each bale forming cycle, the prechamber receives the crop C and a core of the bale is formed inside the prechamber 9. While the core of the bale is being formed, the crop does not enter the compression chamber. Once the core of the bale is formed, the core is transferred to the compression chamber 3. At this point, with the transfer of the bale core to the compression chamber 3, the feeding of the crop C is switched to the compression chamber 3 and thus the crop does not enter the prechamber 9. The crop continues entering the compression chamber 3 and the bale continues to grow. When the bale is formed, the bale formation parameter BP is transmitted to the control unit and the film 6 starts being injected. As explained above, the feeding of the crop is switched to the prechamber with the predetermined time delay responsive to the stop signal. When the stop signal SS is generated, the crop enters the prechamber 9 only and stops entering the compression chamber 3. In particular, the crop enters the prechamber 9 through the first feeding channel 10A and enters the compression chamber 3 through a second feeding channel 10B, the first and the second feeding channel being separate from each other. In an example, the baler 1 includes a movable plate 11 and the control unit moves the movable plate between the first and the second feeding channel 10A, 10B to switch feeding of the crop C between the prechamber and the compression chamber. Thus, the movable plate 11 is used to activate/block the first and the second feeding channel so that the flow of the crop picked up changes between the prechamber and the compression chamber. Therefore, when the movable plate is oriented towards the compression chamber (the movable plate is inside the first feeding channel), the first feeding channel is activated, and when the movable plate is oriented towards the prechamber (the movable plate is inside the second feeding channel), the second feeding channel is active. When an error is detected, the binding device 5 is activated together with the first feeding channel 10A, so that the plastic film is injected into the compression chamber and the crop is fed into the compression chamber through the first feeding channel and the crop continues to be fed into the compression chamber for the time interval. In this example, when the binding signal BS is generated, the control unit may be configured to generate a command to detect one or more error parameters. Said one or more control parameters include the presence of the crop C inside the compression chamber 3 the moment the binding signal BS is generated. Said one or more control parameters also include the position of the movable plate 11 relative to the first and the second feeding channel. In particular, if the movable plate is located in the second feeding channel (hence the second feeding channel 10B is active) the moment the binding signal BS is generated (or the binding command is given manually by the operator) and the compression chamber is detected as not being empty (there is crop inside the compression chamber), the control unit generates an error condition and commands the movable plate to move into the first feeding channel 10A (thereby activating the first feeding channel).

If the compression chamber is empty the moment the binding signal BS is generated (or the binding command is given manually by the operator), the control unit does not activate the binding device (for example, the control unit may generate a signal to prevent the binding device from starting). In such a case, the control unit may also generate an alert to warn the operator that the compression chamber is empty. In an example, said error parameters are detected by the inspection unit 8.

1. A baler for forming round bales comprising:
a pick-up unit configured for picking up crop from the ground;
a compression chamber for receiving the crop from the pick-up unit and for compressing the crop to form the bale, the compression chamber being of fixed diameter;
a plurality of rotating rollers surrounding the compression chamber and configured for imparting a rotational movement to the crop positioned inside the compression chamber;
a binding device, configured for injecting a binding material into the compression chamber so that the bale is wrapped by the binding material as a result of the rotational movement of the crop, the binding material being a plastic film;
a control unit, configured to
receive a bale formation parameter representative of the bale formation inside the compression chamber and to generate, responsive to the bale formation parameter, a binding signal- to command the binding device to inject the plastic film into the compression chamber, and
generate a stop signal representative of the need to stop feeding the crop into the compression chamber,
wherein the control unit is programmed to generate the stop signal with a predetermined time delay with respect to the binding signal, so that the crop continues entering the compression chamber for a time interval after the injection of the plastic film into the compression chamber;
an inspection unit configured to detect errors in the binding process,
wherein the control unit is connected to the inspection unit and is programmed, responsive to detection of an error by the inspection unit, to restart the binding device and restart feeding the crop into the compression chamber, so that the crop continues entering the compression chamber for the time interval after the binding device is restarted.

2. The baler according to claim 1, wherein the inspection unit includes a film sensor, positioned at a predetermined point of the compression chamber and configured to detect the presence of the plastic film on the bale formed in the compression chamber at said predetermined point.

3. The baler according to claim 2, wherein said film sensor is an optical sensor.

4. The baler according to claim 2, wherein the film sensor is positioned between two consecutive rotating rollers of the plurality of rotating rollers.

5. The baler according to claim 2 wherein the film sensor is placed at an upper part of the baler and downstream of the binding device.

6. The baler according to claim 2, wherein the control unit is configured to activate the film sensor in response to the generation of the binding signal.

7. The baler according to claim 1, further comprising:
a prechamber, separate from the compression chamber;
a first feeding channel configured to feed the crop into the prechamber;
a second feeding channel configured to feed the crop into the compression chamber;
wherein the control unit is configured
to activate the first feeding channel and to deactivate the second feeding channel, so that a core of the bale is formed inside the prechamber, and
to subsequently activate the second feeding channel and to deactivate the first feeding channel upon transfer of the bale core formed inside the prechamber to the compression chamber, so that the bale is formed inside the compression chamber, and
to deactivate the second feeding channel and to activate the first feeding channel to switch the feeding of the crop from the second feeding channel to the first feeding channel upon generation of the stop signal,
wherein the control unit is configured, responsive to detection of an error by the inspection unit, to restart the binding device and to switch the feeding of the crop from the first feeding channel to the second feeding channel so that the crop continues entering the compression chamber for the time interval after the binding device is restarted.

8. The baler according to claim 7, further comprising a movable plate, wherein the control unit is configured to activate the first feeding channel and the second feeding channel by moving the movable plate between the first and the second feeding channel so that feeding of the crop is switched between the prechamber and the compression chamber.

9. The baler according to claim 8, wherein the control unit is configured, in response to the binding signal, to command the inspection unit to verify the presence of the crop inside the compression chamber, and to detect the position of the movable plate with respect to the first and the second feeding channel, the control unit being configured to move the movable plate in the first feeding channel, in response to the following conditions being true:
(i) the crop is present inside the compression chamber,
(ii) the movable plate is in the second feed channel.

10. The baler according to claim 1, wherein the control unit is configured to send a stop alert to the operator to stop advancing the baler in response to the generation of the stop signal.

11. The baler according to claim 1 wherein
the control unit is configured to restart feeding the crop into the compression chamber prior to restarting the binding device.

12. The baler according to claim 1, wherein said time delay is a preestablished time window.

13. The baler according to claim 1, 11, wherein said time delay is determined based on a binding parameter.

14. The baler according to claim 13, wherein the binding parameter represents a position of the plastic film on the circumference of the compression chamber.

15. A method for forming round bales comprising the following steps:
providing a baler for forming round bales and having a compression chamber of fixed diameter and a plurality of rotating rollers surrounding the compression chamber;
feeding the crop into the compression chamber of the baler;
rotating the plurality of rotating rollers and imparting a rotational movement to the crop inside the compression chamber through the rotation of the plurality of rotating rollers;
compressing the crop inside the compression chamber to form the bale
through a binding device, injecting a binding material into the compression chamber,
wherein the binding material is a plastic film;
wrapping the bale with the binding material, wherein the binding material moves around the bale on account of the rotational movement of the crop inside the compression chamber;
controlling the injection of the binding material into the compression chamber and the feeding of the crop into the compression chamber by means of a control unit;
detecting a bale formation parameter representative of the bale formation inside the compression chamber;
sending the bale formation parameter to the control unit;
through the control unit,
upon receiving the bale formation parameter, generating a binding signal to command the binding device to inject the plastic film into the compression chamber, and
generating a stop signal representative of the need to stop feeding the crop into the compression chamber,
wherein the control unit generates the stop signal with a predetermined time delay with respect to the binding signal, so that the crop continues entering the compression chamber for a time interval after the injection of the plastic film into the compression chamber;
through an inspection unit, detecting errors in the binding process, the inspection unit being connected to the control unit;
through the control unit, restarting the binding device and feeding the crop into the compression chamber, when an error is detected, so that the crop continues entering the compression chamber for the time interval after the binding device is restarted.

16. The method according to claim 15, comprising the following steps:
positioning a film sensor of the inspection unit at a predetermined point of the compression chamber;
detecting the presence of the plastic film on the bale formed in the compression chamber at said predetermined point, though the film sensor.

17. The method according to claim 16, comprising a step of activating the sensor when the plastic film is injected by the binding device.

18. The method according to claim 15, comprising the following steps:
feeding the crop into a prechamber of the baler through a first feeding channel, the prechamber being separate from the compression chamber;
forming a bale core inside the prechamber;
transferring the bale core to the compression chamber when the core formation is over and stopping crop feed to the prechamber and starting crop feed to the compression chamber through a second feeding channel;
stopping crop feed to the second feeding channel and starting to feed the crop to the first feeding channel when the stop signal is generated;
restarting the binding device and switching the feeding of the crop from the first feeding channel to the second feeding channel when an error in the binding process is detected, so that the crop continues entering the compression chamber for the time interval after the binding device is restarted.

19. The method according to claim 15, wherein a stop alert is sent to the operator to stop advancing the baler, when the stop signal is generated.

20. The method according to claim 15, wherein feeding of the crop is restarted before restarting the injection of the plastic film into the compression chamber, when an error is detected in the binding process.
